(19) United States
(12) Patent Application Publication
(10) Pub. No.: US 2022/0373385 A1
(43) Pub. Date: Nov. 24, 2022

(54) OBJECT-DETECTION USING PRESSURE AND CAPACITANCE SENSORS

(71) Applicant: 3M INNOVATIVE PROPERTIES COMPANY, St. Paul, MN (US)

(72) Inventors: Kristin L. Thunhorst, Stillwater, MN (US); John W. Henderson, St. Paul, MN (US); Esther S. Jeong, St. Paul, MN (US); Sophia S. Liu, St. Paul, MN (US); Andrew W. Long, Woodbury, MN (US); Matthew D. Moore, Lake Elmo, MN (US); Michael E. O'Brien, White Bear Lake, MN (US)

(21) Appl. No.: 17/748,860

(22) Filed: May 19, 2022

Related U.S. Application Data
(60) Provisional application No. 63/190,562, filed on May 19, 2021.

(51) Int. Cl. G01G 19/414; G01N 27/22; G06N 3/08; G06Q 10/08; G06V 10/764; G06V 10/774

(52) U.S. Cl. CPC G01G 19/414; G01N 27/22; G06N 3/08; G06Q 10/087; G06V 10/764; G06V 10/774; G06V 10/82

(57) ABSTRACT

In one aspect, a method of classifying a plurality of objects includes receiving, from a sensor mat, a pressure indication and a capacitance indication, corresponding to the plurality of objects placed on the sensor mat. The method includes determining an object location for each object from the plurality of objects from the pressure and/or capacitance indication. The method includes determining an object profile which includes an object pressure profile and an object capacitance profile for each object. The method includes determining, by one or more processors, the identity of a first object based on a correlation of the determined object profile matching with a first stored object profile from a plurality of first stored object profiles in a data store. The method includes performing at least one action based on the determined identity of the first object.

### BACKGROUND

Inventory control processes can sometimes be difficult for users to itemize and get reimbursed for objects, such as those used in automotive repair on vehicles.

Previously, users may perform completely manual entry, or partially manual entry by using a barcode scanner which requires a user to handle each individual item, or to use RFID tags which can be expensive and/or not feasible to include on individual items. In at least one embodiment, the objects can be loaded into an access-controlled inventory control location and are identified with a unique bar code. An authorized user can open the inventory control location and use a scanner to scan each item. The scanning process results in the identification and recording of which items the technicians are removing.

Computer vision systems can also be used to perform inventory tasks but may have problems performing object identification in a resource-efficient manner.

When new consumable objects are received to restock the shop inventory, they are unloaded by someone (jobber or shop employee) and scanned and loaded into an inventory control location (e.g., cabinet) so that accurate inventory can be maintained.

Automated systems can make the user experience more seamless so the objects can be reported accurately against a specific repair order for a specific vehicle, and make the check-in and check-out processes less disruptive to an employee or jobber normal workflow.

### BRIEF SUMMARY

In one aspect, a method of classifying a plurality of objects includes receiving, from a sensor mat, a pressure indication and a capacitance indication, corresponding to the plurality of objects placed on the sensor mat, determining, by one or more processors, an object location for each object from the plurality of objects from the pressure and/or capacitance indication, where the object location is in an x, y coordinate plane of the sensor mat, determining, by one or more processors, an object profile includes an object pressure profile for each object corresponding to an object location based on the pressure indication, and an object capacitance profile for each object at the object location based on the capacitance indication, the object pressure profile includes weight distribution by area and area of the sensor mat occupied of the object, and the object capacitance profile includes capacitance (distribution by area) of the object, determining, by one or more processors, the identity of a first object based on a correlation of the determined object profile matching with a first stored object profile from a plurality of first stored object profiles in a data store, and performing at least one action based on the determined identity of the first object.

In at least one embodiment, the identification of objects includes the addition of other sensors and sensing technology. One such option is to add a vision system which has an adequate line of sight to the sensor mat or bin. Images can be obtained apriori from the vision system and a ground truth for the item identification can be provided via a training set. The vision or camera system could be used independently or in combination with the pressure and capacitance sensor profiles discussed herein to increase the accuracy of the object identification.

In at least one embodiment, a motion sensor, such as an accelerometer, can be added to storage locations within an inventory control location. When the pressure and capacitance profiles provide inadequate confidence or accuracy in the object identification process, and/or to increase the rate of object identification, the additional input of the location of movement in the inventory control location when the object was removed or added can be additionally used as a criteria to help down-select the list of available options for the computer processor or machine learning algorithm. By the combination of inputs from the multiple sensor sets, the accuracy, and potentially the rate, of object identification can be improved.

The method may also include where the correlation is based on the determined object pressure profile matching with a stored object pressure profile, or the determined object capacitance profile matching with a stored object capacitance profile.

The method may also include where determining the object location includes performing background subtraction for each object outside of the received pressure indication.

The method may also include determining a quantity of material within the first object from the object capacitance or pressure profile, determining whether the quantity of material has changed to a second quantity of material, and in response to the quantity of material being changed, providing an amount of the second quantity of material to the inventory control process.

The method may also include determining whether the first object is still present on the sensor mat, in response to the first object not being present, removing the first object from or adding to the inventory control process.

The method may also include receiving a second pressure indication and a second capacitance indication from the sensor mat, determining, by one or more processors, an object location for a second object from the plurality of objects, where the object location is in an x, y coordinate plane of the sensor mat, determining, by one or more processors, an object profile for the second object corresponding to an object location based on the pressure indication and the capacitance indication, the object profile includes weight distribution by area, area occupied, and capacitance, determining the identity of the second object based on the determined object profile matching with a second stored object profile from the plurality of stored object profiles, performing at least one action based on the determined identity of the second object.

In one aspect, a method includes receiving, from a sensor mat, a pressure indication and a capacitance indication, corresponding to a plurality of objects placed on the sensor mat, generating a heat map for a plurality of objects on the sensor mat, classifying a first object on the heat map with a trained machine learning model that is trained on a training set of heat map images for a plurality of objects, determining, by one or more processors running the trained machine learning model, the identity of the first object using the trained machine learning model, performing at least one action based on the determined identity of the first object.

The method may also include where the heat map includes a first heat map showing the magnitude of the pressure indication and a second heat map showing the magnitude of the capacitance indication.

The method may also include where the trained machine learning model is a deep learning model using a neural network circuitry, where the classifying the first object on the heat map further includes extracting, with the deep learning model, a proposed region of the heat map, the heat map being an input to the deep learning model, and classifying, with a trained classifier, the heat map based on the proposed region, the proposed region being an input to the trained classifier.

The method may also include where the determining the identity of the first object includes applying the trained machine learning model to the heat map to determine a probability that the first object exists in the proposed region and an extent of the proposed region, determining if the probability and the extent are within a threshold, and determining that the object is the first object if the threshold is satisfied by the probability and the extent.

The method may also further include receiving a training set including a plurality of training images related to the plurality of objects, establishing a ground truth for a class label with a bounding box on at least some of the plurality of training images in the training set, the bounding box encompasses at least a majority of a measurement zone on a training image, where the class label is associated with the identity of the object, providing the training set to the machine learning model, allowing the machine learning model to analyze the plurality of training images to train the machine learning model and form the trained machine learning model.

In at least one embodiment, a non-transitory computer-readable storage medium including instructions that, when processed by a computer, configure the computer to perform any aspect of the methods above.

In at least one embodiment, a computer can include a processor and a memory storing instructions that, when executed by the processor, configure the computer to perform any aspects of the methods above.

For example, in one aspect, a computer includes a processor. The computer also includes a memory storing instructions that, when executed by the processor, configure the computer to receive, from a sensor mat, a pressure indication and a capacitance indication, corresponding to the plurality of objects placed on the sensor mat, determine, by one or more processors, an object location for each object from the plurality of objects from the pressure and/or capacitance indication, where the object location is in an x, y coordinate plane of the sensor mat, determine, by one or more processors, an object profile includes an object pressure profile for each object corresponding to an object location based on the pressure indication, and an object capacitance profile for each object at the object location based on the capacitance indication, the object pressure profile includes weight distribution by area and area of the sensor mat occupied of the object, and the object capacitance profile can include capacitance (distribution by area) of the object, determine, by one or more processors, the identity of a first object based on a correlation of the determined object profile matching with a first stored object profile from a plurality of first stored object profiles in a data store, and perform at least one action based on the determined identity of the first object.

In one aspect, a computer includes a processor. The computer also includes a memory storing instructions that, when executed by the processor, configure the computer to receive, from a sensor mat, a pressure indication and a capacitance indication, corresponding to a plurality of objects placed on the sensor mat, generate a heat map for a plurality of objects on the sensor mat, classify a first object on the heat map with a trained machine learning model that is trained on a training set of heat map images for a plurality of objects, determine, by one or more processors running the trained machine learning model, the identity of the first object using the trained machine learning model, perform at least one action based on the determined identity of the first object.

Other technical features may be readily apparent to one skilled in the art from the following figures, descriptions, and claims.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an aspect of the subject matter in accordance with one embodiment.

FIG. 2 illustrates an aspect of the subject matter in accordance with one embodiment.

FIG. 3 depicts an illustrative computer system architecture that may be used in accordance with one or more illustrative aspects described herein.

FIG. 4 illustrates a routine 400 in accordance with one embodiment.

FIG. 5 illustrates a routine 500 in accordance with one embodiment.

FIG. 6 illustrates a subroutine block 600 in accordance with one embodiment.

FIG. 7 illustrates a subroutine block 700 in accordance with one embodiment.

### DETAILED DESCRIPTION

Aspects of the present disclosure relate to a computer-implemented identification of a plurality of objects based on a capacitance indication and a pressure indication from a sensor mat and an optional secondary identification process. Aspects of the present disclosure also include the combination of signals from either a vision system or motion sensing technology with the capacitance and pressure indication to increase accuracy and/or identification rate of the plurality of objects.

Some systems, such as those found in U.S. Pat. No. 10,679,181, may utilize sensor mat but only in defined lanes. Further, some of these systems may also utilize imaging for user proximity, and not for use with the object itself.

Computer software, hardware, and networks may be utilized in a variety of different system environments, including standalone, networked, remote-access (aka, remote desktop), virtualized, and/or cloud-based environments, among others.

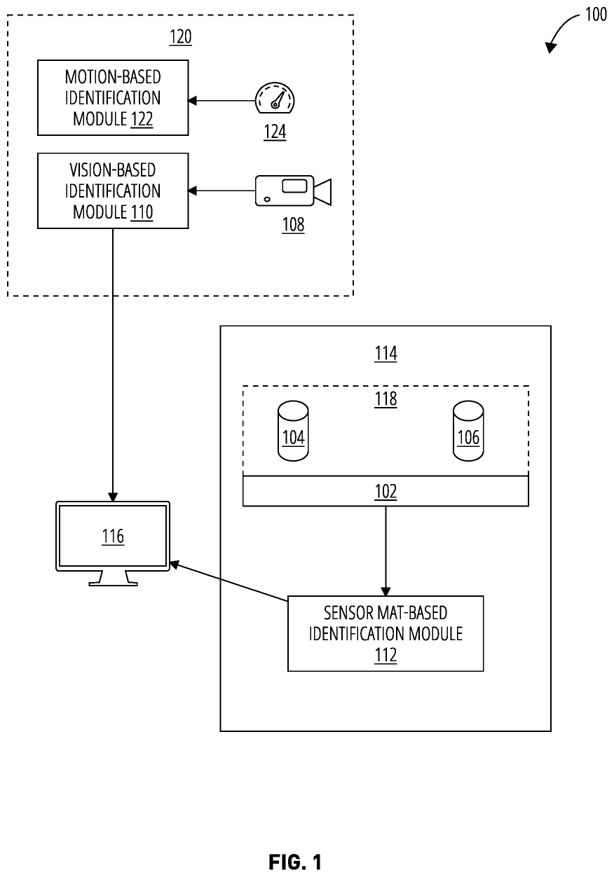

FIG. 1 illustrates a system 100 for identification of a plurality of objects. The system 100 can be part of an inventory control process or system.

The system 100 can include a plurality of objects, shown as object 104 and object 106. The plurality of objects can be those found in an inventory of a commercial enterprise such as objects to be sold by the commercial enterprise to a customer, objects to be distributed within the commercial enterprise, or consumable items for use by the commercial enterprise. In at least one embodiment, the plurality of objects can be automotive materials such as a box of abrasive sheets, a tube of adhesive, polishes, seam sealers, or combinations thereof. In one example, the plurality of objects can be non-discrete such as partial tubes of seam sealers.

The plurality of objects can be placed on the sensor mat 102. The sensor mat 102 can be a device configured to register various pressure indications and capacitance indications in response to weight (from an object or bin 118). The sensor mat 102 and sensor mat-based identification module 112 can be similar to the capacitive mat that is described by Wu et. al., Capacitivo: Contact-Based Object Recognition on Interactive Fabrics using Capacitive Sensing, Proceedings of the 33rd Annual Symposium on User Interface Software and Technology, October 2020.

Several approaches exist to make a weight or pressure-based sensor. One of these approaches uses a somewhat compressible, generally polymeric-based material that has electrically conductivity which is related in a certain pressure range to the force (weight/pressure) applied to it. The concentration of carbon black matched with the correct compressibility causes the conductivity to be a function of the pressure applied to the material. Examples of this type of material are commercially available under the trade designations Empore or Velostat by 3M (Saint Paul, Minn.).

The sensor mat 102 can be communicatively coupled to the sensor mat-based identification module 112. The sensor mat-based identification module 112 can be a computer that is configured to determine the identity of an object based on readings from the sensor mat 102 in methods described further herein. The sensor mat-based identification module 112 can also be a remote computer system (e.g., a cloud-based network).

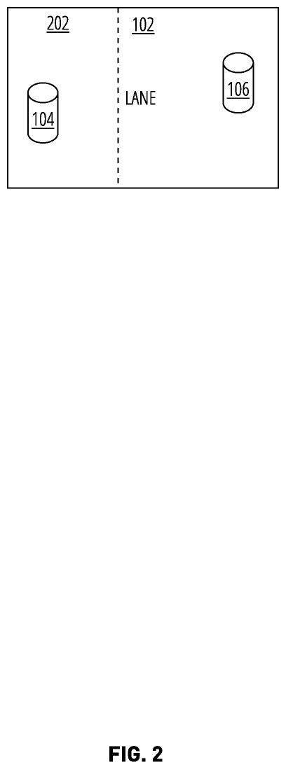

The plurality of objects can be retained on the sensor mat 102 directly. For example, FIG. 2 illustrates the placement of the plurality of objects, object 104 and object 106, on the sensor mat 102. For example, the sensor mat 102 can rest within the bin 118. As shown, the resulting signals from the plurality of objects will change based on their respective positions in the x,y coordinates on the sensor mat 102. In at least one embodiment, the object 104 can be in a first lane 202 and the object 106 can be in a lane 102. The object 104 can be separated from object 106 and be analyzed separately.

In at least one embodiment, the plurality of objects can be placed within a bin 118 which rests on the sensor mat 102. For example, a user can place the object 104 and object 106 in the bin 118 which can be placed on the sensor mat 102. For example, references to an object (e.g., 104 or 106) can envision the object itself being a bin with additional objects placed inside of the bin. The sensor mat 102 registers various pressure indications and capacitance indications from the bin 118. The load balance within the bin 118 may change based on the distribution of the plurality of objects and the configuration of the bin 118. For example, if the bin 118 is supported by four posts, then the weight of the plurality of objects can be concentrated on some of the posts. In at least one embodiment, the sensor mat 102 can be placed inside of the bin 118. In at least one embodiment, the bin 118 can be partially formed of conductive plastic and sensor mat 102 is integral with the bin 118.

A plurality of bins 118 can be placed on the sensor mat 102 and within the inventory control location 114. The inventory control location 114 can have a plurality of sensor mats and a plurality of bins 118. In at least one embodiment, the object 104 can be another bin configured to hold a plurality of objects. In this case, the sensor mat-based identification module 112 can determine the weight of the plurality of objects in the bin. The sensor mat-based identification module 112 can also determine the identity of at least one of the plurality of objects in the bin based on the weight.

In at least one embodiment, the sensor mat 102 is lane indeterminate, meaning that a single object can occupy multiple lanes of an inventory system. For example, a seam sealer can occupy two or more lanes in an inventory system. In at least one embodiment, the sensor mat 102 can occupy multiple lanes within a shelf of a inventory control location 114. In other embodiments, the sensor mat 102 can define a lane within the shelf.

The sensor mat 102 can exist as part of a sensor mat-based identification module 112 or system thereof. The sensor mat-based identification module 112 can read the signals from the sensor mat 102 in order to identify any of the plurality of objects. The sensor mat-based identification module 112 can further be communicatively coupled to computer 116 and any inventory control process therein.

For example, the sensor mat-based identification module 112 can capture data of the plurality of objects individually, which can indicate the object weight and area, other physical/electrical property. The sensor mat-based identification module 112 can associate the data with known object attributes already pre-loaded into a reference database. In at least one embodiment, machine learning algorithms can be used to assist in the capture of object attributes.

In one example, the sensor mat 102 can be used by a user, e.g., technicians, or pickers, as they remove consumable items from a common inventory location (inventory control location 114) for use in a specific repair, or replace partially consumed items back into inventory stock. In one example, the user could remove the desired consumable objects from a cabinet or shelf and place them on the sensor mat 102. Several items could be placed on the sensor mat 102 at the same time. The objects can be identified by sensor mat-based identification module 112. The identity of the objects can be provided to the computer 116 which can automatically deduct or add the identified objects from inventory in an inventory control process. In at least one embodiment, the computer 116 can initiate an automatic reorder process based on min/max inventory rules pre-programmed into the inventory control process.

In at least one embodiment, the sensor mat-based identification module 112 can use the sensor mat 102 to measure the weight of object 104 and the pressure profile of the object 104. The sensor mat-based identification module 112 can accurately determine the identity of plurality of objects placed on the sensor at one time. This technique could also be combined with secondary identification module 120 which could optionally include a camera system 108. In at least one embodiment, the sensor mat-based identification module 112 can use a contact-based object recognition system utilizing not only the weight of the item, but also other properties of the object such as capacitance heatmap properties.

In at least one embodiment, the sensor mat-based identification module 112 can use the sensor mat 102 to determine the identity of the plurality of objects placed on the sensor mat 102 at one time, but may be more suited for determining the identity of a single object at one time.

In at least one embodiment, an optional secondary identification module 120 can also be used by the computer 116.

For example, the secondary identification module 120 can use a vision-based identification module 110 which can determine the identity of the plurality of objects based on images of the plurality of objects. The vision-based identification module 110 can use a camera system 108 positioned such that the camera system 108 can capture the object. Cameras are advantageous in that they can enable the coverage of a very large area with small devices. Cameras alone can present challenges with detecting multiples in a stack unambiguously, and with the potential for certain hand/arm/body positions blocking view. Various vision-based object recognition techniques are known such as those described in https://machinelearningmastery.com/object-recognition-with-deep-learning/by Jason Brownlee.

In at least one embodiment, the secondary identification module 120 can include a motion-based identification module 122 that can contribute to determining the identity of an object based on a motion sensor 124. The motion sensor 124 can be configured to detect movement of an object. For example, the motion sensor 124 can be an accelerometer, or an optical device (such as an ultrasonic sensor) that is capable of determining motion. For example, the motion sensor 124 can be independent from the camera system 108. The motion sensor 124 can be proximate to the object, directly attached to the object, or attached to a bin or other location inside the inventory control location 114.

In at least one embodiment, the secondary identification module 120 can allow the computer 116 to localize an area of the inventory control location 114 prior to using the sensor mat-based identification module 112 to reduce the computing resources used by the computer 116 to implement the sensor mat-based identification module 112. For example, a plurality of motion sensors 124 attached to a plurality of objects. In this example, if a user bumps some of the plurality of objects in a bin 118 when accessing an object in the bin 118, then the movement of the bin 118 can be used as a selection criteria so that the weight of the adjacent bins are excluded from the analysis, or the selection criteria weighting factor for bin 118 is increased.

In at least one embodiment, the bins are pre-configured (e.g., a bin at row, column contains x and is part of shelf A) and the object 104 can be tracked based on the bin 118 location and user interaction with the bin 118. The secondary identification module 120 can augment the sensor mat-based identification module 112 via shelves being spring loaded so removing mass allows the shelves to rise.

An aspect of the present disclosure is that the secondary identification module 120 can help to augment the sensor mat-based identification module 112 by providing an additional data point to verify the ground truth. For example, if the weight of an object 104 does not definitively establish the identity (e.g., at least 90% probability of the object having the identity), the computer 116 can use the secondary identification module 120 to either narrow down the possible identities (by eliminating identities from selection based on secondary identification selection criteria, e.g., visual identification results in some of the possible options for sensor mat-based identification being eliminated based on lack of probability of being the object), or determine the identity of the object 104 (e.g., by modifying the ranking or weighting factors of the most probable options of the sensor mat-based identification).

In at least one embodiment, the secondary identification module 120 or the computer 116 can coordinate with the inventory control process to further narrow down the objects detected using the sensor mat 102. For example, the computer 116 can communicate with the inventory control process so that items that were checked out of inventory within a certain time period (e.g., in the past week) are analyzed by the sensor mat 102. This process can further enable faster detection and/or identification of the object by the computer 116 by eliminating irrelevant objects.

In at least one embodiment, the computer 116 can confirm that a “partially consumed item” (e.g., tube of structural adhesive, seam sealer, or other consumable) is being checked back into or returned to inventory based on the sensor mat-based identification module 112 and vision-based identification module 110. For example, a partial quantity, e.g., ½ full tube of adhesive, is made available as inventory in the inventory control location based on 1) object recognition of the tube using the sensor mat 102 and/or secondary identification module 120, and 2) the difference in weight of the tube. By this mechanism accurate accounting of materials used in a specific repair can be completed. This enables record-keeping in case customers are interested in certified repairs which document that specific materials and/or amounts of specific materials were consumed in a specific repair on a specific vehicle, and/or to help support conformance to a specified repair procedure. This can also help support additional item consumption for explanations to insurance companies as body shops attempt to get reimbursed for work completed on a specific repair order.

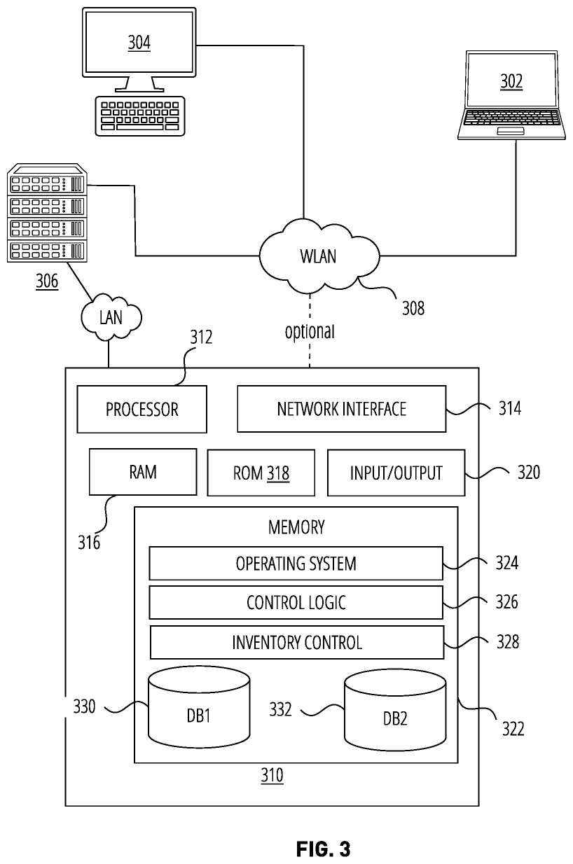

FIG. 3 illustrates one example of a system architecture and data processing device that may be used to implement one or more illustrative aspects described herein in a standalone and/or networked environment. Various network nodes, data server 310, web server 306, computer 304, and laptop 302 may be interconnected via a wide area network 308 (WAN), such as the internet. Other networks may also or alternatively be used, including private intranets, corporate networks, LANs, metropolitan area networks (MANs) wireless networks, personal networks (PANs), and the like. Network 308 is for illustration purposes and may be replaced with fewer or additional computer networks. A local area network (LAN) may have one or more of any known LAN topologies and may use one or more of a variety of different protocols, such as ethernet. Devices, data server 310, web server 306, computer 304, laptop 302 and other devices (not shown), may be connected to one or more of the networks via twisted pair wires, coaxial cable, fiber optics, radio waves or other communication media.

The term “network” as used herein and depicted in the drawings refers not only to systems in which remote storage devices are coupled together via one or more communication paths, but also to stand-alone devices that may be coupled, from time to time, to such systems that have storage capability. Consequently, the term “network” includes not only a “physical network” but also a “content network,” which is comprised of the data—attributable to a single entity—which resides across all physical networks.

The components may include data server 310, web server 306, and client computer 304, laptop 302. Data server 310 provides overall access, control and administration of databases and control software for performing one or more illustrative aspects described herein. Data server 310 may be connected to web server 306 through which users interact with and obtain data as requested. Alternatively, data server 310 may act as a web server itself and be directly connected to the internet. Data server 310 may be connected to web server 306 through the network 308 (e.g., the internet), via direct or indirect connection, or via some other network. Users may interact with the data server 310 using remote computer 304, laptop 302, e.g., using a web browser to connect to the data server 310 via one or more externally exposed web sites hosted by web server 306. Client computer 304, laptop 302 may be used in concert with data server 310 to access data stored therein, or may be used for other purposes. For example, from client computer 304, a user may access web server 306 using an internet browser, as is known in the art, or by executing a software application that communicates with web server 306 and/or data server 310 over a computer network (such as the internet).

Servers and applications may be combined on the same physical machines, and retain separate virtual or logical addresses, or may reside on separate physical machines. FIG. 3 illustrates just one example of a network architecture that may be used, and those of skill in the art will appreciate that the specific network architecture and data processing devices used may vary, and are secondary to the functionality that they provide, as further described herein. For example, services provided by web server 306 and data server 310 may be combined on a single server.

Each component data server 310, web server 306, computer 304, laptop 302 may be any type of known computer, server, or data processing device. Data server 310, e.g., may include a processor 312 controlling overall operation of the data server 310. Data server 310 may further include RAM 316, ROM 318, network interface 314, input/output interfaces 320 (e.g., keyboard, mouse, display, printer, etc.), and memory 322. Input/output interfaces 320 may include a variety of interface units and drives for reading, writing, displaying, and/or printing data or files. Memory 322 may further store operating system software 324 for controlling overall operation of the data server 310, control logic 326 for instructing data server 310 to perform aspects described herein, and inventory control process 328 providing secondary, support, and/or other functionality which may or may not be used in conjunction with aspects described herein. The control logic may also be referred to herein as the data server software control logic 326. Functionality of the data server software may refer to operations or decisions made automatically based on rules coded into the control logic, made manually by a user providing input into the system, and/or a combination of automatic processing based on user input (e.g., queries, data updates, etc.).

Memory 322 may also store data used in performance of one or more aspects described herein, including a first database 332 and a second database 330. In some embodiments, the first database may include the second database (e.g., as a separate table, report, etc.). That is, the information can be stored in a single database, or separated into different logical, virtual, or physical databases, depending on system design. Web server 306, computer 304, laptop 302 may have similar or different architecture as described with respect to data server 310. Those of skill in the art will appreciate that the functionality of data server 310 (or web server 306, computer 304, laptop 302) as described herein may be spread across multiple data processing devices, for example, to distribute processing load across multiple computers, to segregate transactions based on geographic location, user access level, quality of service (QoS), etc.

One or more aspects may be embodied in computer-usable or readable data and/or computer-executable instructions, such as in one or more program modules, executed by one or more computers or other devices as described herein. Generally, program modules include routines, programs, objects, components, data structures, etc. that perform particular tasks or implement particular abstract data types when executed by a processor in a computer or other device. The modules may be written in a source code programming language that is subsequently compiled for execution, or may be written in a scripting language such as (but not limited to) HTML or XML. The computer executable instructions may be stored on a computer readable medium such as a nonvolatile storage device. Any suitable computer readable storage media may be utilized, including hard disks, CD-ROMs, optical storage devices, magnetic storage devices, and/or any combination thereof. In addition, various transmission (non-storage) media representing data or events as described herein may be transferred between a source and a destination in the form of electromagnetic waves traveling through signal-conducting media such as metal wires, optical fibers, and/or wireless transmission media (e.g., air and/or space). various aspects described herein may be embodied as a method, a data processing system, or a computer program product. Therefore, various functionalities may be embodied in whole or in part in software, firmware and/or hardware or hardware equivalents such as integrated circuits, field programmable gate arrays (FPGA), and the like. Particular data structures may be used to more effectively implement one or more aspects described herein, and such data structures are contemplated within the scope of computer executable instructions and computer-usable data described herein.

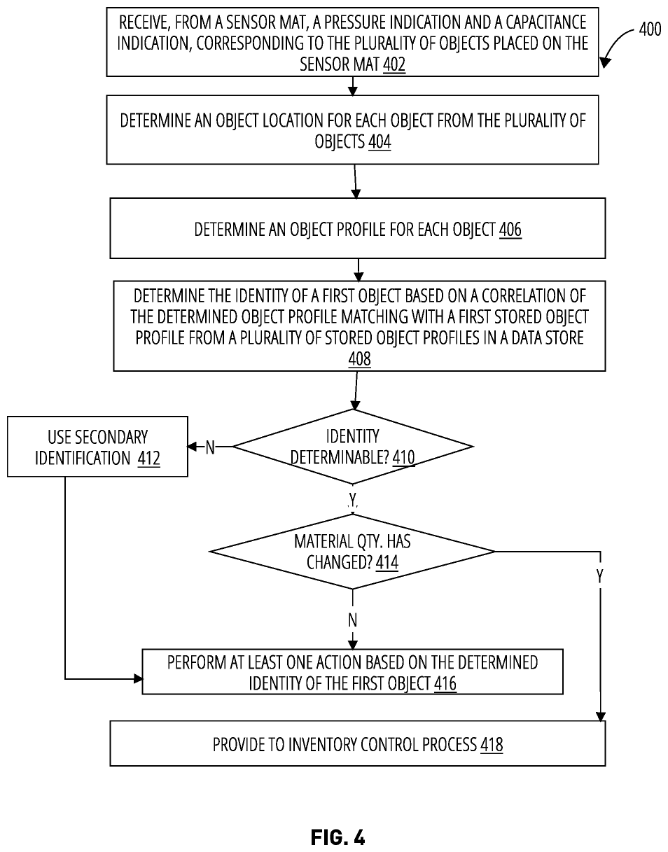

FIG. 4 illustrates a routine 400 for determining an identity of a plurality of objects based on readings from a sensor mat.

As described herein, a plurality of objects can be placed on the sensor mat causing a variety of changes in the electrical signal. In block 402, routine 400 receives, from a sensor mat, a pressure indication, and a capacitance indication, corresponding to the plurality of objects placed on the sensor mat.

In block 404, routine 400 determines, by one or more processors, an object location for each object from the plurality of objects. The object location can be in an x,y coordinate plane of the sensor mat. The object location can be established based on the pressure indication and/or the capacitance indication produced by the sensor mat.

In at least one embodiment, the pressure indication could assist with quantity identification while the capacitance indication can be used for object identity. For example, a stack of objects that are the same within the same footprint can use a pressure indication to determine the weight of the stacked objects and use capacitance to determine the overall shape of the footprint. In another example, items of the same type that are discrete items placed on the sensor mat at the same time can utilize the capacitance indication for object identity.

In at least one embodiment, the one or more processors can be configured to perform background subtraction for each object. For example, parts of the sensor mat with weak to no pressure indications can be determined to be background. The measurement zone for each object can be identified which can help determine the area affected by the object. For example, the object may have a strong pressure indication toward a point of the object, but the signal may degrade outside of the point.

In block 406, routine 400 determines, by one or more processors, an object profile for each object. In at least one embodiment, the object profiles can include an object pressure profile or an object capacitance profile for each object corresponding to the object location. In at least one embodiment, the object pressure profile can be based on the pressure indication, and the object capacitance profile can be based on the capacitance indication. The object pressure profile includes weight distribution by area and area of the sensor mat occupied of the object.

The object capacitance profile can include the capacitance (distribution by area) of the object. For example, the object profile can also include properties related to information collected with other sensors used in secondary identification. The object profile can be lane agnostic. For example, the scenario where unitA_weight*n==unitB_weight*m where A and B are in different lanes on the same shelf. Thus, the same object may be included on multiple lanes.

In block 408, routine 400 determines, by one or more processors, the identity of a first object based on a correlation of the determined object profile from block 406 matching with a first stored object profile from a plurality of stored object profiles in a data store.

In at least one embodiment, the correlation is based on the determined object pressure profile matching with a stored object pressure profile, and/or the determined object capacitance profile matching with a stored object capacitance profile. For example, if the determined object profile indicates a certain capacitance indication or weight distribution by area for an object, the one or more processors can establish a metric or a score of each of the values. This metric can be compared to other metrics within a plurality of stored object profiles (i,e., a stored object pressure profile and a stored object capacitance profile) to determine whether there is a correspondence. In at least one embodiment, the determination of the identity can be accomplished using techniques such as those described by Wu et al., or other techniques described herein except that both capacitance indication and pressure indication are used.

In decision block 410, the routine 400 can determine whether the identity of the first object is determinable. If the identity of an object is not determinable, then the routine 400 can use a secondary identification process in block 412.

The secondary identification process can use a variety of non-weight/capacitance-based techniques to determine the identity of the first object. In at least one embodiment, the secondary identification process can use a vision-based identification. For example, the routine 400 can combine cameras and load cells to enable a matrix tracking approach. Specifically, a camera could watch from overhead, which would be able to identify the “column” of the bin the user is reaching into. Similarly, all bins on that shelf (“row”) would be tracked by the same load cell. The combination of column and row allows for pinpointing which product is being removed, and the mass loss after user interaction reveals how many units. In this way the system could be covered with n=rows load cells instead of n=rows*columns (a cost reduction of rows*(columns-1)). Alternatively, a specific location could be designated as the sensor mat system for object check in and check out. One specific vision system could have a clear line of sight to the specific sensor mat location. In this case, a lane approach could be used, or is not necessary to use.

Multiple cameras can be supplemented with a single load cell for the entire system, however resolution typically scales in proportion to max weight. Thus, to account for the potential capacity of the entire inventory control location might decrease resolution to an unsatisfactory amount, preventing the detection of the lightest single unit in the system (e.g., a single abrasive disc, or an adhesive static mixing nozzle).

In addition, the combination of load cells and cameras can allow determination into the contents of outer packaging. For example, with a camera, one may see users grab an abrasive disc, however if one single disc remains and the user takes the whole box (with it closed) a camera system will not know if n=1 or n=box_quantity. Via load cells and storing the corresponding min/max/mean of both unit weight as well as associated packaging, the removal of a box is now a matter of a) visually differentiating box vs. disc, and b) calculating [total weight−packaging]/unit_weight to determine the number of units taken.

Another advantage could come in using only the weight to determine product, with the camera only used to identify arm position, not object recognition. The computational complexity is drastically reduced, as product images in many angles do not need to be acquired, stored, and updated across all devices to enable this recognition task.

In at least one embodiment, the secondary identification can use a motion-based identification. For example, the motion-based identification can use one or more motion sensors located proximate to the object. For example, a motion sensor can be placed on the inventory control location (e.g., a shelf or bin) or directly on each object. As a user removes an object, the motion sensor can determine whether the object was moved, and eliminate certain objects from consideration based on a region analysis of the motion data. For example, if a motion sensor on a shelf indicates that something was moved, then only the objects that were on the shelf (as determined by the inventory control process) are possible identities for the sensor mat-based identification. This enables the computer to screen out other non-relevant identities for the object in order to enable faster processing.

New products can easily be added by the user simply weighing a unit and its packaging. Adding packages could automatically track how many were added during stocking (which would admittedly be better with image detection, as one could see if the user adds outer packaging, or dumps the products loose into bins). In certain cases, the inclusion or exclusion of outer packaging is determined as the inventory control location is being set up.

If the secondary identification process is used, then the routine 400 can also perform a reconciliation of the two identities (one determined by the sensor mat-based identification module, the other determined using a secondary identification module).

One method of reconciliation is to generate a prediction value corresponding to likelihood that the weight distribution is the same object identified in the secondary identification for all profiles with a likelihood greater than some threshold of confidence (say, a 50% confidence threshold). In the event that both the secondary identification module and the sensor mat-based identification module say the same known object profile is the likeliest profile, where the next highest confidence is below some delta threshold (say, the next highest prediction is at least 10% less confident than the top choice) the modules agree and the first object is labelled as the agreed-upon object from those modules.

In cases where the sensor mat-based identification module 112 and secondary identification module 120 do not agree, as may happen in a case where there are multiple items having the same weight and similar packaging, one or both modules may output their top several choices as being within a very close confidence range, or output that there is no very confident pressure or capacitance profile prediction, and allow the other module to be the tie-breaker. In cases where one module is extremely confident in its prediction choice and the other module is extremely unconfident of its prediction choice, the confident module's output may be taken for the identity prediction. In cases where neither module is confident enough of the object's identity, the modules can request more input data, or after some period of time simply label the determined object profile as an unknown identity. If there is a human in the loop able to confidently label the determined object profile as a known object, the modules can update their corresponding known object profile.

In decision block 414, the routine 400 can determine whether quantity of material has changed. In at least one embodiment, the quantity of material may be based on the weight in the object pressure profile. For example, the first object may have a stored weight from the last instance. Thus, the routine 400 can determine if the weight has changed from the last instance (i.e., corresponding to a material usage).

The quantity can also be related to the object pressure profile. For example, if the pressure profile of a tube of sealant changes, then the change may indicate that there is less quantity than before. The routine 400 can determine whether the quantity of material has changed to a second quantity of material. in response to the quantity of material being changed, providing an amount of the second quantity of material to the inventory control process in block 418 where the inventory control process can log the usage of the material.

In some cases, items are removed from the inventory control accounting process and in other cases, items can be added back into the inventory control process. To increase the rate of object identification and reduce the set of eligible objects for the computer processor to match or the machine learning model to identify, objects being returned to the inventory management process could first be identified as associated with a particular purchase order, a specific technician who removed the items, a specific repair order, or a specific physical inventory control location or device within the shop. Due to the reduction in the number of eligible choices, the object identification process could experience increased accuracy or rate of identification. The workflow can also be simplified or made more natural for the technician, employee or jobber, to return or check-in items into the inventory control through the order of operations. For example, if objects are placed onto the sensor mat or bin, or into the area of imaging by the vision system prior to the opening or unlocking of an inventory control location, those objects could be assumed as being returned to inventory, rather than being checked out of inventory. Otherwise, if the inventory control location is accessed or unlocked prior to the placement of objects on the sensor mat or within the vision system sensing area, then the items could be assumed as being checked out or removed from inventory.

Certain objects are designed to be removed from an inventory control process, partially consumed, and then returned to the inventory control process. These items may have the same capacitance heat map before and after partial consumption, but the pressure heat map may be altered due to the change in material quantity. To increase the accuracy and probability of object matching by the computer processor and or machine learning algorithm, these items can be identified as having a weight or pressure profile within a range of values. By this method, the amount of material consumed from the specific object while it was checked-out of the inventory control system can be identified and allocated to a specific technician or repair order and accounted for in the inventory control system. To increase the speed and accuracy of the object matching identification when an object is returned (checked in) to inventory after partial consumption, a smaller subset of objects from which to match the specific object identity can be identified by limiting the list of eligible items by technician or employee identity, by repair order, or by recently checked-out items from that specific inventory control location.

In at least one embodiment, if the last instance was the determination in decision block 410, e.g., where the object was identified, then the routine 400 can optionally continue to block 402 where the computer can determine if the first object is still present on the sensor mat. If there is no weight change, then the routine 400 can continue to block 416.

In block 416, routine 400 performs at least one action based on the determined identity of the first object. The various actions can include recording the first object in an inventory control process. For example, the inventory control process can determine when an object is removed from inventory or whether the weight has changed for the item.

In at least one embodiment, the routine 400 can use the identity to trigger functions of a inventory control location. For example, an indicator light in the inventory control location can activate in response to a particular object being present or absent. In at least one embodiment, the indicator light or audible signal or a combination, can be associated with an object location within the inventory control location. For example, removing an object from the shelf makes an indicator light turn from green to red, and optionally a beep noise to indicate successful registration of a change.

In response to any changes within the sensor mat (e.g., an object being moved), the routine 400 can repeat the process. For example, the routine 400 can include receiving a second pressure indication and a second capacitance indication from the sensor mat, determining, by one or more processors, an object location for a second object from the plurality of objects, determining, by one or more processors, an object profile for the second object corresponding to an object location based on the pressure indication and the capacitance indication, determining the identity of the second object based on the determined object profile matching with a second stored object profile from a plurality of stored object profiles, and performing at least one action based on the determined identity of the second object.

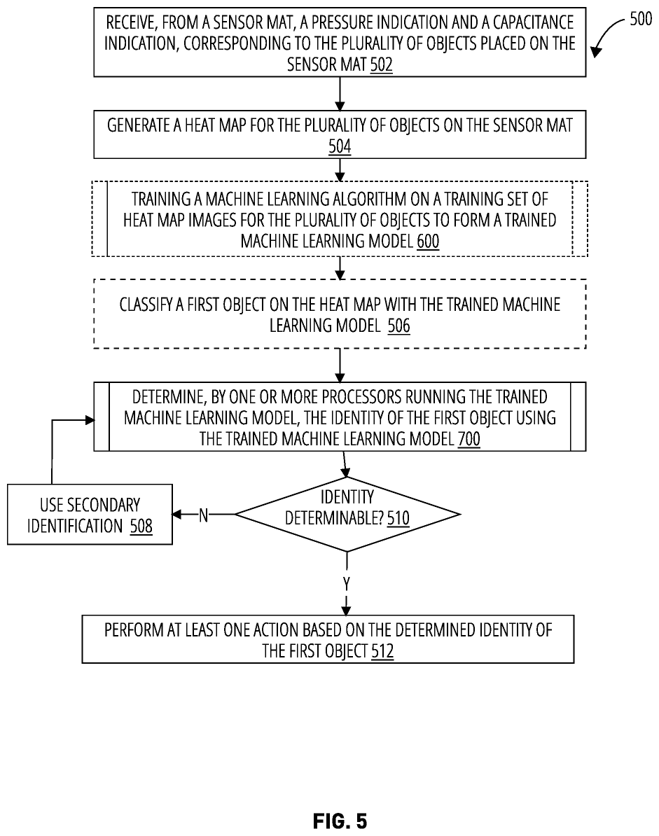

FIG. 5 illustrates a routine 500 for identifying a first object from a plurality of objects based on a sensor mat.

Similar to block 402, in block 502, routine 500 receives, from a sensor mat, a pressure indication and a capacitance indication, corresponding to the plurality of objects placed on the sensor mat.

In block 504, routine 500 generates a heat map for the plurality of objects on the sensor mat. The heat map can describe the granular variations of both the capacitance indication and pressure indication of each object on the sensor mat. In at least one embodiment, the heat map can include a first heat map showing the magnitude of the pressure indication and a second heat map showing the magnitude of the capacitance indication. For example, the computer can separate the channels corresponding to the capacitance indication and pressure indication.

In at least one embodiment, the individual weights may be optionally determined since the heat map and patterns of weight distribution can be evaluated by the computer. The heat map can be used to generally determine the classification of the object (e.g., an abrasive disc, a paint cup, or a seam sealer tube). In at least one embodiment, the computer can further use the heat map to classify the object and then use the classification to more quickly identify the object based on the secondary identification.

Some objects, such as a tube of sealer or structural adhesive, among other items, can have a discontinuous pressure or capacitance heat map when placed on the sensor mat. The identification of heat map identity and extent, and the bounding box identification process discussed subsequently, can be constructed to allow and correctly identify these items which have discontinuous pressure or capacitance profiles.

Optionally, in subroutine block 600, the machine learning algorithm can be trained on a training set of heat map images for a plurality of objects to form a trained machine learning model. For example, the machine learning algorithm can be a deep learning model and utilize training to determine weights for a convolutional neural network. Instead of images of the objects themselves as the training set, the machine learning algorithm can use the heat map of the objects effect on the sensor mat as the training set.

In block 506, routine 500 classifies a first object on the heat map with a trained machine learning model that is trained on a training set of heat map images for the plurality of objects. This classification can occur using a variety of techniques, multi-class classification (e.g., k-nearest neighbors, decision trees, naive Bayes, random forest, or gradient boosting), multi-label classification, or imbalanced classification. In at least one embodiment, the routine 500 can use a convolutional neural network (CNN), R-CNN, Fast-R-CNN, Faster R-CNN, or Fastest R-CNN to perform the classification.

In at least one embodiment, the trained machine learning model is a deep learning model using a neural network circuitry. In at least one embodiment, the deep learning model can use a region proposal network such as that found in the Faster R-CNN. The trained machine learning model can extract, with the deep learning model, a proposed region of the heat map. The heat map can be an input to the deep learning model. After the proposed region is extracted, then the computer can classify, with a trained classifier, the heat map based on the proposed region. The proposed region can also be an input to the trained classifier.

In at least one embodiment, block 506 can be optional or incorporated into aspects of subroutine block 700.

In subroutine block 700, routine 500 determines, by one or more processors running the trained machine learning model, the identity of the first object using the trained machine learning model. The identity can be determined based on the probability of the first object being associated with a heat map based on the feature weights within the trained machine learning model.

In block 512, routine 500 performs at least one action based on the determined identity of the first object. The types of actions in block 512 can be similar to those in block 416 in FIG. 4.

In at least one embodiment, a first trained machine learning model can be based on a training set from the first heat map and a second trained machine learning model can be based on a training set from a second heat map in block 504. The first and second trained machine learning models can be used to classify the first object in block 506 and determine the identity of the first object in subroutine block 700. In at least one embodiment, the determination of the identity in subroutine block 700 can be based on the first heat map and the second heat map independently. For example, subroutine block 700 can generate two possible identities. If the two possible identities are not in agreement, e.g., the first possible identity is different than the second possible identity, then the computer can implement various techniques to select a single possible identity.

For example, in decision block 510, the computer can determine that the first possible identity has a higher associated confidence than the second possible identity. Thus, the first possible identity can be selected for the object and block 512 can commence. In another example, if the identity is not determinable in decision block 510 (e.g., if the first possible identity and second possible identity are equally likely), then the computer can implement a secondary identification process block 508 to allow determination of the identity for the first object or second object.

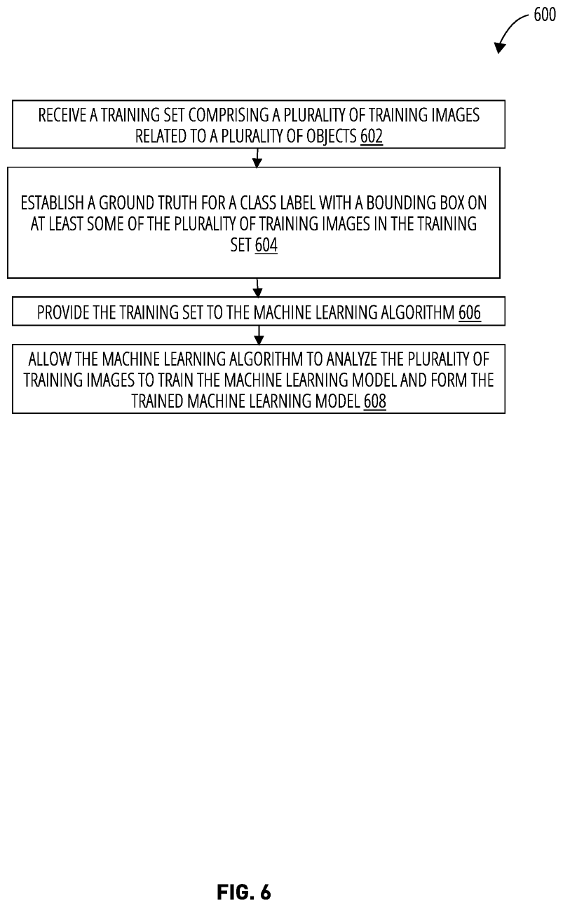

FIG. 6 illustrates subroutine block 600 describing the training of the machine learning algorithms in greater detail. For example, in block 602, subroutine block 600 can receive a training set comprising a plurality of training images related to a plurality of objects. These training images can be heat map type images of the plurality of objects in an inventory data store. For example, objects that are not governed by the inventory control process (e.g., a non-stocked item), may not be loaded onto the training set due to resource constraints.

In block 604, subroutine block 600 can establish a ground truth for a class label with a bounding box on at least some of the plurality of training images in the training set. The bounding box can encompass at least a majority of a measurement zone on a training image. In at least one embodiment, the class label is associated with the identity of the object. For example, the class label of “seam sealer #2” can be associated with an actual seam sealer product.

In block 606, subroutine block 600 provides the training set to the machine learning algorithm. In block 608, subroutine block 600 allows the machine learning algorithm to analyze the plurality of training images to train the machine learning algorithm and form the trained machine learning model.

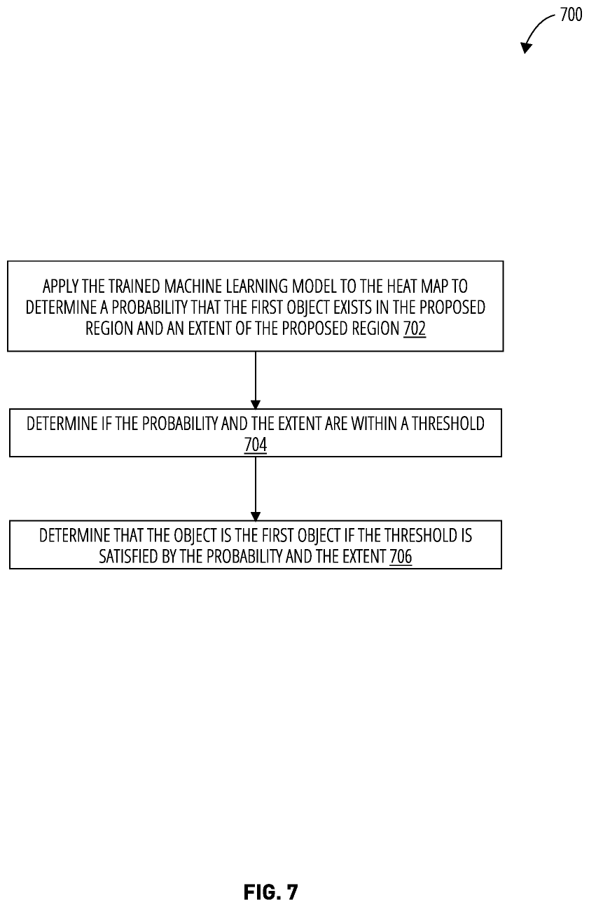

FIG. 7 illustrates a subroutine block 700 of determining the identity of the first object using a trained machine learning model. The computer having one or more processors can implement the subroutine block 700.

In block 702, subroutine block 700 can apply the trained machine learning model to the heat map generated in block 506. For example, if the subroutine block 700 uses a region proposal network, then the subroutine block 700 can determine a probability that the first object exists in the proposed region and an extent of the proposed region.

In block 704, subroutine block 700 determines if the probability and the extent are within a threshold. For example, if the heat map has a region that indicates a 50% probability of being a seam sealer adhesive at a first extent, and a 55% probability of being a seam sealer adhesive at a second extent, but the threshold is 70% probability, then the subroutine block 700 may determine that the identity of the first object is indeterminable. If the probability and the extent are within a threshold, then the subroutine block 700 can continue to block 706.

In block 706, subroutine block 700 determines that the object is the first object if the threshold is satisfied by the probability and the extent.

“Bin” refers to a receptacle for storing objects.

“Capacitance indication” refers to an indication that leads to a determination of an ability of an object to store an electric charge. The capacitance indication is independent from the pressure indication even if both capacitance indications and pressure indications are determined using a capacitive sensor mat.

“Heat map” refers to a representation of data in the form of a map or diagram in which data values are represented as colors or signal intensity or other finite values.

“Inventory control location” refers to an area, room, shelf, cabinet, cart, or other similar storage location for objects of interest to the shop, technician, or jobber. In one aspect, the inventory control location refers to an area such as a shop floor where objects are stored. In another aspect, the inventory control location can refer to a cabinet where a collection of objects of interest are housed.

“Lane” refers to any narrow or well-defined passage, track, channel, or course within the inventory control location. For example, the lane can refer to a physical layout for objects to move in-and-out of the inventory control location (e.g., if an object is routinely placed on and off the shelf in a certain location between two bins).

“Object” refers to an item that is capable of being tracked in an inventory control process. For example, an object can be a portion of a consumable item such as half a tube of adhesive.

“Pressure indication” refers to an indication that leads to a determination of continuous force exerted on a sensor mat by an object.

“Sensor mat” refers to a mostly planar sensor configured to produce pressure indications and capacitance indications.

What is claimed is:

1. A method of classifying a plurality of objects comprising:
receiving, from a sensor mat, a pressure indication and a capacitance indication, corresponding to the plurality of objects placed on the sensor mat;
determining, by one or more processors, an object location for each object from the plurality of objects from the pressure and/or capacitance indication, wherein the object location is in an x, y coordinate plane of the sensor mat;
determining, by one or more processors, an object profile, the object profile comprising:
an object pressure profile for each object corresponding to an object location based on the pressure indication, the object pressure profile includes weight distribution by area and area of the sensor mat occupied of the object, and
an object capacitance profile for each object at the object location based on the capacitance indication, the object capacitance profile includes capacitance distribution by area of the object;
determining, by one or more processors, the identity of a first object based on a correlation of the determined object profile matching with a first stored object profile from a plurality of first stored object profiles in a data store; and
performing at least one action based on the determined identity of the first object.

2. The method of claim 1, wherein the correlation is based on the determined object pressure profile matching with a stored object pressure profile, or the determined object capacitance profile matching with a stored object capacitance profile.

3. The method of claim 1, wherein determining the object location comprises:
performing background subtraction for each object outside of the received pressure indication.

4. The method of claim 1, wherein determining the object location comprises identifying a measurement zone for each object based on an expected object location.

5. The method of claim 1, wherein to perform at least one action comprises:
providing an identity of the first object to an inventory control process.

6. The method of claim 5, further comprising:
determining a quantity of material within the first object from the object pressure profile;
determining whether the quantity of material has changed to a second quantity of material; and
in response to the quantity of material being changed, providing an amount of the second quantity of material to the inventory control process.

7. The method of claim 6, further comprising:
determining whether the first object is still present on the sensor mat;
in response to the first object not being present, removing the first object from or adding to the inventory control process.

8. The method of claim 1, wherein the first object is itself a bin configured to hold a plurality of objects.

9. The method of claim 8, further comprising:
determining the weight of the plurality of objects in the bin; and
determine the identity of at least one of the plurality of objects in the bin based on the weight.

10. The method of claim 1, further comprising determining the first object identity based on using a secondary identification process, the secondary identification is a vision-based identification or a motion-based identification.

11. A non-transitory computer-readable storage medium including instructions that, when processed by a computer, configure the computer to perform the method of claim 1.

12. A method comprising:
receiving, from a sensor mat, a pressure indication and a capacitance indication, corresponding to a plurality of objects placed on the sensor mat;
generating a heat map for the plurality of objects on the sensor mat,
classifying a first object on the heat map with a trained machine learning model that is trained on a training set of heat map images for a plurality of objects;
determining, by one or more processors running the trained machine learning model, the identity of the first object using the trained machine learning model;
performing at least one action based on the determined identity of the first object.

13. The method of claim 12, wherein the heat map comprises a first heat map showing the magnitude of the pressure indication and a second heat map showing the magnitude of the capacitance indication.

14. The method of claim 12, wherein the trained machine learning model is a deep learning model using a neural network circuitry, wherein the classifying the first object on the heat map further comprises:
extracting, with the deep learning model, a proposed region of the heat map, the heat map being an input to the deep learning model; and
classifying, with a trained classifier, the heat map based on the proposed region, the proposed region being the input to the trained classifier.

15. The method of claim 12, wherein the determining the identity of the first object comprises:
applying the trained machine learning model to the heat map to determine a probability that the first object exists in the proposed region and an extent of the proposed region;
determining if the probability and the extent are within a threshold; and
determining that an object is the first object if the threshold is satisfied by the probability and the extent.

16. The method of claim 12, further comprising:
receiving a training set comprising a plurality of training images related to the plurality of objects;
establishing a ground truth for a class label with a bounding box on at least some of the plurality of training images in the training set, the bounding box encompasses at least a majority of a measurement zone on a training image, wherein the class label is associated with the identity of the first object;
providing the training set to the machine learning model;
allowing the machine learning model to analyze the plurality of training images to train the machine learning model and form the trained machine learning model.

17. A computer comprising:
a processor; and
a memory storing instructions that, when executed by the processor, configure the computer to:
receive, from a sensor mat, a pressure indication and a capacitance indication, corresponding to a plurality of objects placed on the sensor mat;
determine, by one or more processors, an object location for each object from the plurality of objects from the pressure or capacitance indication, wherein the object location is in an x, y coordinate plane of the sensor mat;
determine, by one or more processors, an object profile comprising an object pressure profile for each object corresponding to an object location based on the pressure indication, and an object capacitance profile for each object at the object location based on the capacitance indication, the object pressure profile includes weight distribution by area and area of the sensor mat occupied of the object, and the object capacitance profile includes capacitance distribution by area of the object;
determine, by one or more processors, the identity of a first object based on a correlation of the determined object profile matching with a first stored object profile from a plurality of first stored object profiles in a data store; and
perform at least one action based on the determined identity of the first object.

18. The computer of claim 17, wherein the correlation is based on the determined object pressure profile matching with a stored object pressure profile, or the determined object capacitance profile matching with a stored object capacitance profile.

19. The computer of claim 17, wherein to perform at least one action comprises:
provide an identity of the first object to an inventory control process;
wherein the instructions further configure the computer to:
determine whether the first object is still present on the sensor mat;
in response to the first object not being present, remove the first object from or add the object to the inventory control process.

20. The computer of claim 19, wherein the instructions further configure the computer to:
determine a quantity of material within the first object from the object capacitance profile;
determine whether the quantity of material has changed to a second quantity of material; and
in response to the quantity of material being changed, provide an amount of the second quantity of material to the inventory control process.
